(19) United States
(12) Patent Application Publication
(10) Pub. No.: US 2025/0123497 A1
(43) Pub. Date: Apr. 17, 2025

(54) ASSEMBLY STRUCTURE OF TEMPLE AND SIDE SHIELD

(71) Applicant: PROHERO GROUP CO., LTD., TAINAN CITY (TW)

(72) Inventor: PEN-WEI CHEN, TAINAN CITY (TW)

(21) Appl. No.: 18/485,405

(22) Filed: Oct. 12, 2023

(51) Int. Cl. G02C 5/14; G02C 7/16; G02C 9/00

(52) U.S. Cl. CPC G02C 5/146; G02C 7/16; G02C 9/00

(57) ABSTRACT

The invention relates to an assembly structure of temple and side shield, which includes a temple, a spectacles frame and a side shield. The temple comprises a slot provided on thereof, two engaging protrusions each provided on a pair of corresponding walls of the slot, and a first introduction bevel provided on each side of the two engaging protrusions. The side shield includes an insert piece upward protruded on the top end thereof, a through hole passing through the wall of the insert piece, and two second introduction slopes arranged on both sides of the tip of the insert piece. Insert the insert piece of the side shield, and under the guidance of the first introduction bevels and the second introduction slopes, after the tip of the insert piece passes through the two engaging protrusions, the two engaging protrusions are correspondingly embedded in the through hole of the insert piece.

### BACKGROUND OF THE PRESENT INVENTION

### Field of Invention

The present invention relates to an assembly structure of temple and side shield, and in particular, to a side shield structure assembled on the temple and used to block light or foreign objects to protect the eyes.

### Description of Related Arts

The purpose of installing side wings on both sides of the glasses is mainly to block particles, chemicals, and other foreign objects splashing into the eyes or strong light shining into the eyes from the sides of the glasses, in order to avoid injury to the eyes.

Referring to TWM612747U, the spectacles structure is disclosed, which mainly includes a frame body. The two sides of the frame body are convexly provided with a pivoting part. The two pivoting parts are each pivoted by a temple. The two side walls of the frame body are each provided with a notch, and a number of embedded holes are arranged in the notch. Two shields are respectively arranged on both sides of the frame body, and several inlays are provided on the opposite inner side edges of the two shields. The inlays are respectively embedded in each embedded hole of the frame body. The middle part of the inner surface of the shield is provided with a concave surface, and the concave surface is for the front end of the temple to be inserted. Two decorative strips are respectively provided in the notches on both sides of the frame body, and several inlays are provided on the opposite inner side edges of the two decorative strips. The inlays are respectively embedded in each embedded hole of the frame body. Users can install shields or decorative strips depending on usage conditions. Since it is emphasized that the shields or decorative strips can be replaced and assembled according to the usage conditions, in order to facilitate disassembly and assembly, the combination between the shield or decorative strip and the frame body is easily separated by force, and the protective effect is not reliable enough.

Referring to TWM576665U, which provides a combination structure for eyeglass-side shielding piece, which includes a spectacles main body and two side shielding pieces. The spectacles main body has a frame in front thereof, and the frame has temples on both sides. An engagement portion is positioned in front of the temples near the frame, and the engagement portion has a slot with an insertion opening below. At least one engaging body is provided in the slot, and a channel corresponding to the front and back directions of the temple is provided between the engaging body and the top end of the slot. The side shielding pieces are correspondingly provided and each side shielding piece has a shield portion below, with an insert piece portion for inserting into the slot of the temple positioned above the shield portion. At least one buckle portion is provided above the insert piece portion, corresponding to the engaging body of the temple. The lower part of the buckle portion is provided with buckle grooves corresponding to the front and rear directions of the temples. The insert piece portion of the side shielding piece can be inserted from bottom to top into the slot of the engagement portion of the temple through the insertion opening, allowing for displacement in the front and rear directions of the side shielding piece to enable the buckle slot to engage the engaging body. The side shielding piece of the case is inserted into the slot of the temple with its insert piece portion, and then the side shielding piece is moved forward so that the buckle slot is engaged with the engaging body to achieve the purpose of positioning the side shielding piece. However, when the side shielding piece is pushed backward by force, it will detach from the slot of the temple. Similarly, the case is unable to ensure the stability of the side shielding piece and temple connection, resulting in insufficient protection effectiveness.

The inventor of the present invention has developed the present invention in view of the shortcomings of the above-mentioned existing previous cases in actual implementation and use.

### SUMMARY OF THE PRESENT INVENTION

A main purpose of the present invention is to provide an assembly structure of the temple and side shield, which does not require the use of hand tools and ensures that the side shield can be stably assembled on the temple after assembly and cannot be easily separated.

The above-mentioned purpose of the present invention is achieved by the following technologies.

An assembly structure of temple and side shield, including a temple, a spectacles frame and a side shield, wherein the temple includes a slot with an opening facing downward is provided at one end thereof adjacent to the end assembled with the spectacles frame, two engaging protrusions protruding toward each other, each provided on a pair of corresponding walls of the slot, and a first introduction bevel provided on each side of the two engaging protrusions facing the opening, wherein the first introduction bevel is inclined from bottom to top and in the direction in which the engaging protrusions protrude, wherein the side shield includes an insert piece arranged on the top end thereof, a through hole passing through the wall of the insert piece, and two second introduction slopes arranged on both sides of the tip of the insert piece, wherein the second introduction slopes are inclined from top to bottom toward the outside, wherein the insert piece is inserted through the opening, and under the guidance of the first introduction bevels and the second introduction slopes, the tip of the insert piece smoothly passes through the gap between the two engaging protrusions and further enters the depth of the slot, at this time, the two engaging protrusions are correspondingly embedded in the through hole of the insert piece, so that the side shield is stably assembled on the temple.

The assembly structure of the temple and side shield as mentioned above, the temple has a through hole provided on the wall thereof facing the person's face and at a position corresponding to the slot, wherein the through hole is connected with the slot.

The assembly structure of the temple and side shield as mentioned above, the through hole on the insert plate that penetrate the wall of the insert plate are also allowed to be designed in the form of grooves that are concave toward the center of the wall of the insert plate on both side surfaces of the insert plate without penetrating the wall of the insert plate.

### BRIEF DESCRIPTION OF THE DRAWINGS

FIG. 1 is a perspective view illustrating an assembly structure of temple and side shield of the present invention applied to a spectacle frame.

FIG. 2 is a partial exploded view illustrating the assembly structure of the temple and side shield according to the present invention.

FIG. 3 is a partial exploded sectional view illustrating the assembly structure of the temple and side shield according to the present invention.

FIG. 4 is a partial assembly sectional view illustrating the assembly structure of temple and side shield according to the present invention.

### DETAILED DESCRIPTION OF THE PREFERRED EMBODIMENT

In order to have a more complete and clear disclosure of the technical content, the purpose of creation and the effect achieved by the present invention, it is explained in detail below, and refer to the disclosed drawings and drawing numbers together.

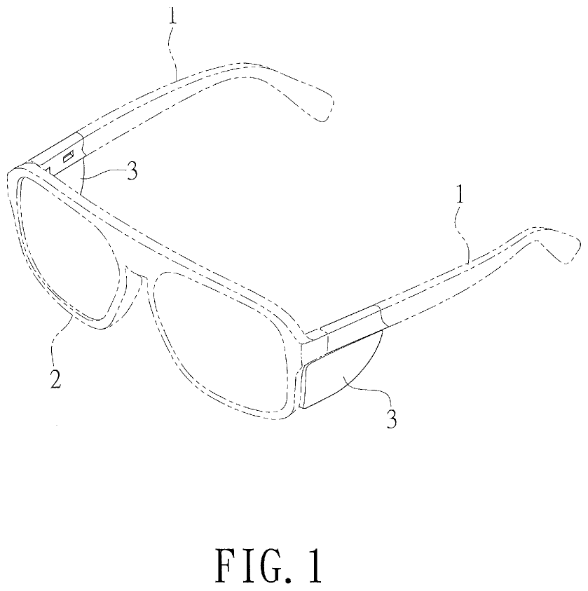

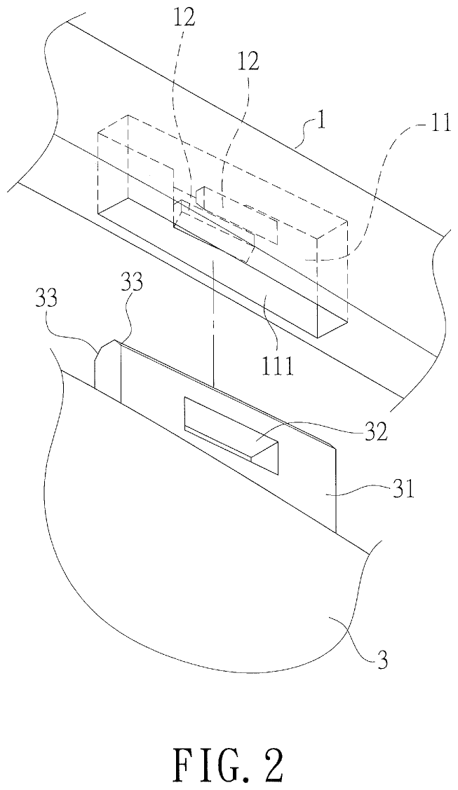

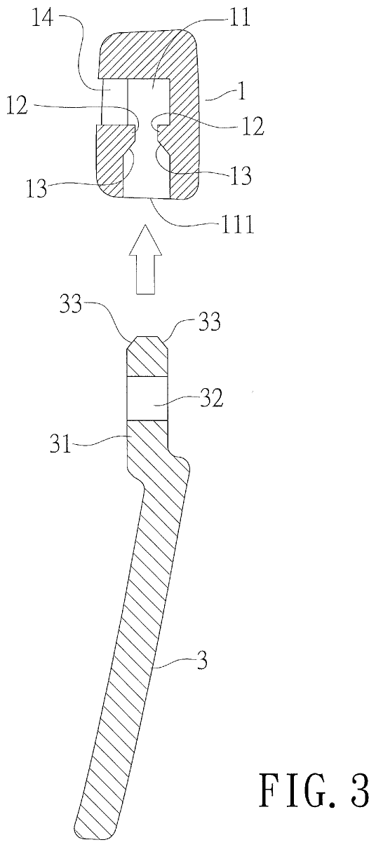

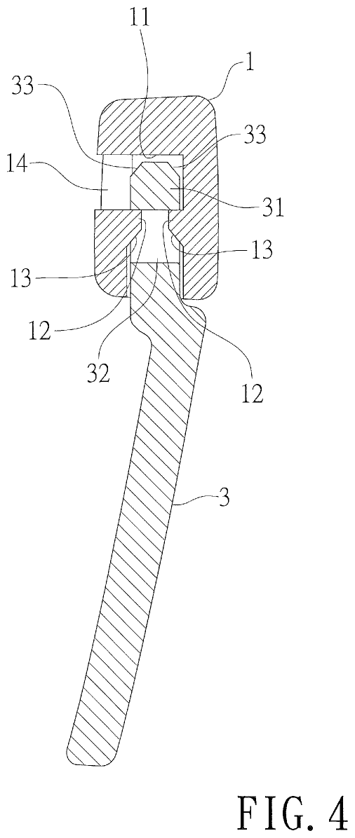

### Referring to FIGS. 1-4.

The assembly structure of temple and side shield of the present invention includes a temple 1, a spectacles frame 2 and a side shield 3, wherein the temple 1 includes a slot 11 with an opening 111 facing downward is opened at one end thereof adjacent to the end assembled with the spectacles frame 2, two engaging protrusions 12 protruding toward each other, each provided on a pair of corresponding walls of the slot 11, and a first introduction bevel 13 provided on each side of the two engaging protrusions 12 facing the opening 111, wherein the first introduction bevel 13 is inclined from bottom to top and in the direction in which the engaging protrusions 12 protrudes, wherein the side shield 3 includes an insert piece 31 arranged on the top end thereof, a through hole 32 passing through the wall of the insert piece 31, and two second introduction slopes 33 on both sides of the tip (i.e. head) of the insert piece 31, wherein the second introduction slopes 33 are inclined from top to bottom toward the outside.

When assembling (referring to 3 and 4), the insertion of the insert piece 31 of the side shield 3 is done through the opening 111 of the slot 11 of the temple 1. Since the two engaging protrusions 12 in the slot 11 protrude beyond the deep path of the insert piece 31 inserted into the slot 11, through the cooperation of the first introduction bevel 13 on the side facing the opening 111 of the engaging protrusions 12 and the corresponding inclined surface with the second introduction slopes 33 on both sides of the insert piece 31 at the front end, ensuring the insert piece 31 can easily pass through the gap between the two engaging protrusions 12 and reach the depth of the slot 11. Then, the two engaging protrusions 12 are inserted into the through hole 32 of the insert piece 31, so that the top surfaces of the two engaging protrusions 12 contact the upper wall of the through hole 32, forming a state that prevents the insert piece 31 of the side shield 3 from being separated from the slot 11 of the temple 1. That is, the minimum gap between the two engaging protrusions 12 must be smaller than the wall thickness of the insert piece 31 of the side shield 3 to ensure that after the two engaging protrusions 12 are inserted into the through hole 32 on the insert piece 31 of the side shield 3, the side shield 3 will not easily fall off from the temple 1 due to force.

In a preferred embodiment of the assembly structure of the temple and side shield according to the present invention, the temple 1 has a through hole 14 provided on the wall thereof facing the person's face and at a position corresponding to the slot 11, wherein the through hole 14 is connected with the slot 11. This structural design is for smooth demoulding when the temple 1 is provided with the slot 11 and the engaging protrusions 12.

In a preferred embodiment of the assembly structure of the temple and side shield of the present invention, the insert piece 31 is originally provided with a through hole 32 that penetrates the wall thickness of the insert piece 31. It can also be designed in a manner that does not penetrate the wall of the insert piece 31. Instead, two grooves design that are concave toward the center of the wall of the insert piece 31 are formed on the two side surfaces of the insert piece 31 corresponding to the two engaging protrusions 12. That is, the through hole 32 do not penetrate the wall of the insert piece 31, but form recessed grooves (not shown in the figure) on both sides of the insert piece 31. This method can also provide the engaging protrusions 12 to engage the side shield 3, so that the side shield 3 can be firmly assembled on the temple 1.

What is claimed is:

1. An assembly structure of temple and side shield, comprising a temple, a spectacles frame and a side shield, wherein the temple comprises a slot with an opening facing downward is provided at one end thereof adjacent to the end assembled with the spectacles frame, two engaging protrusions protruding toward each other, each provided on a pair of corresponding walls of the slot, and a first introduction bevel provided on each side of the two engaging protrusions facing the opening, wherein the first introduction bevel is inclined from bottom to top and in the direction in which the engaging protrusions protrude, wherein the side shield comprises an insert piece arranged on the top end thereof, a through hole passing through the wall of the insert piece, and two second introduction slopes arranged on both sides of the tip of the insert piece, wherein the second introduction slopes are inclined from top to bottom toward the outside, wherein the insert piece is inserted through the opening, and under the guidance of the first introduction bevels and the second introduction slopes, the tip of the insert piece smoothly passes through the gap between the two engaging protrusions and further enters the depth of the slot, at this time, the two engaging protrusions are correspondingly embedded in the through hole of the insert piece, so that the side shield is stably assembled on the temple.

2. The assembly structure of temple and side shield as claimed in claim 1, wherein the temple has a through hole provided on the wall thereof facing the person's face and at a position corresponding to the slot, wherein the through hole is connected with the slot.

3. The assembly structure of the temple and side shield as claimed in claim 2, wherein the through hole on the insert plate that penetrate the wall of the insert plate are also allowed to be designed in the form of grooves that are concave toward the center of the wall of the insert plate on both side surfaces of the insert plate without penetrating the wall of the insert plate.

4. The assembly structure of the temple and side shield as claimed in claim 1, wherein the through hole on the insert plate that penetrate the wall of the insert plate are also allowed to be designed in the form of grooves that are concave toward the center of the wall of the insert plate on both side surfaces of the insert plate without penetrating the wall of the insert plate.
